(19) United States
(12) Patent Application Publication
(10) Pub. No.: US 2019/0164392 A1
(43) Pub. Date: May 30, 2019

(54) METHOD FOR WARNING A USER, A WEARABLE WARNING SYSTEM AND USE OF THE SYSTEM

(71) Applicant: SANDMANDEN STORSÆKKE SERVICE V/ FLEMMING PETERSEN, Daugård (DK)

(72) Inventor: Flemming Billie PETERSEN, Daugård (DK)

(21) Appl. No.: 16/320,935

(22) PCT Filed: Jul. 11, 2017
(86) PCT No.: PCT/DK2017/050235

§ 371 Date: Jan. 25, 2019

(30) Foreign Application Priority Data
Jul. 28, 2016 (DK) PA 2016 70561

(51) Int. Cl. G08B 3/10; G08B 21/18; G08B 21/22; A01M 31/00; G06F 3/01; G06F 1/16

(52) U.S. Cl. CPC G08B 3/1016; G08B 21/182; G08B 21/22; G06F 1/163; G06F 3/011; G06F 3/017; A01M 31/00

(57) ABSTRACT

A method of warning a user (20) and a wearable warning system (10) helping the user (20) wearing said wearable warning system (10), while the user is trying to sneak closer to a prey. Said wearable warning system (10) comprises at least one acoustic sensor (30) for measuring at least one sound level, an evaluation unit (40) having a user-interface (42) and said evaluation unit (40) configured for activating an alert unit (50) as a function of at least one measured sound level and at, least one noise threshold.

### FIELD OF INVENTION

The present invention relates to a method and a wearable warning system for helping a user sneak closer to a prey or to help the user stay quieter than the ambient sound.

### BACKGROUND OF THE INVENTION

The invention relates to a wearable warning system for helping a user or a group of users hunt a prey.

At the present day a plurality of headphones for e.g. a game hunter has several features for helping the game hunter find a prey. The headphones may help the game hunter by amplifying the ambient sound level to improve the user's hearing. This will make it easier for the game hunter to hear any nearby noise. Furthermore, by increasing the ambient sound level, the rustling of leaves or a zipper zipping is increased making the hunter more aware of the sounds produced by hunters. The sound heard by the hunter is however dependent on the amplification of the headphones, thus the headphones do not give a direct indication of when the game hunter is making too much noise.

Warning systems warning the user or users, if the sound level exceeds a certain level, already exist. However, the problem solved by the warning systems is related to safety as a person exposed to a high sound level may get hearing damage, which may lead to tinnitus or deterioration in hearing. Thus, these warning systems cannot help a user sneaking up on a prey as the noise threshold is too high.

### DESCRIPTION

A method for warning a user sneaking up on a prey comprises an act of providing the user with at least one acoustic sensor, an evaluation unit having a processor, an alert unit and a storage unit for storing computer-readable information. A sound level is measured at one or more acoustic sensors. The evaluation unit compares one or more of the measured sound levels with at least one noise threshold, and if one of the sound levels is above a noise threshold, the evaluation unit will activate the alert unit. The alert unit will upon activation generate a warning.

The storage unit may be a hard disk drive or a solid state disk or a flash memory or an SD card.

In an embodiment the evaluation unit may only activate the alert unit, if a measured sound level is between two noise thresholds. If the user is a hunter hunting game, the hunter is aware that a rifle will make a loud noise when fired. Therefore, a warning is unnecessary and a nuisance to the hunter.

A method for warning a group of users sneaking up on a prey comprises an act of providing each user with a wearable warning system comprising of at least one acoustic sensor, an evaluation unit and an alert unit. The wearable warning systems are linked together by communication means, thereby becoming a group of warning systems. The wearable warning systems will each measure a sound level at one or more acoustic sensors.

The evaluation units each compare one or more of the measured sound levels with at least one noise threshold, and if one of the sound levels is above a noise threshold, said evaluation unit will activate one or more alert units in the group of warning systems. Each alert unit will upon activation generate a warning.

In an embodiment each evaluation unit may only activate the alert units in the group of warning systems, if a measured sound level is between two noise thresholds. Furthermore, if the measured sound level is above an obvious loud noise threshold, e.g. a gunshot, a communication is sent to all wearable warning systems, that no alarm unit should be activated. If the group of users is a group of hunters hunting game, the hunters are aware that a rifle will make a loud noise when fired. Therefore, a warning is unnecessary and a nuisance to the group of hunters.

In an embodiment the method is used by an ornithologist to sneak closer to birds. Thus, the word prey should be interpreted broadly, as the ornithologist does not want to capture or kill the birds but merely observe the birds.

The method for warning a user sneaking up on a prey may further comprise calibrating acts.

The method may comprise an act of providing the wearable warning system further comprising a motion unit for determining when the user is stationary.

The motion unit may be a gyroscope, which is capable of measuring whether the user is in motion or stationary.

The motion unit may be a capacitor, which is capable of measuring whether the user is in motion or stationary.

The storage unit may be a computer-readable storage such as a SD-card or hard drive or a temporary computer-readable storage such as RAM.

The method for warning a user sneaking up on a prey may further comprise an act of determining when the user is stationary using the motion unit.

If and while the user is stationary, an act of measuring the sound level at one or more acoustic sensors and an act of storing the measured sound levels on the storage unit may be performed.

If the user is stationary in a predetermined time duration, an act of adjusting the one or more noise thresholds of one or more acoustic sensors as a function of the measured sound level at the one or more acoustic sensors at the evaluation unit may be performed.

The evaluation unit may be a single unit capable of both comparing sound levels with noise thresholds and adjusting the noise thresholds as a function of the measured sound level.

The evaluation unit may be formed of a first and a second module each having a processor The first module compares sound levels with noise thresholds, and the second module adjusts the noise thresholds as a function of the measured sound level.

The predetermined time duration may be chosen from time ranges of 0.5-5 s or 2-4 s or 3 s. If the time duration is shorter than 0.5 s, the calibrations may become too uncertain, and if the time duration is above 5 s, it would force the user to be stationary for an unnecessary long period. This would especially limit the usefulness of the method and of the wearable warning system for a user sneaking up on a prey. Thus, the optimal predetermined time duration is between 0.5-5 s.

Studies have shown that a predetermined time duration chosen in a time range of 2-4 s is an optimal compromise between the need for a good calibration and the usefulness of the method and of the wearable warning system. The most optimal predetermined time duration is 3 s.

The predetermined time duration may be chosen by the user or be hidden from the user.

If the user moves before the predetermined time duration has elapsed, nothing happens, and no act of adjusting the one or more noise thresholds of one or more acoustic sensors will be performed.

This enables the user to interact and control the wearable warning system without using hands, thus freeing the hands for other tasks such as holding and/or handling a gun or rifle or shotgun.

Furthermore, this method for calibrating a wearable warning system enables the system and method to utilise the expert knowledge of the hunter, because the hunter can control the wearable warning system and control when to perform a new calibration by standing still in a predetermined time duration. If the ambient noise level changes due to changes in weather conditions or due to changes in the landscape, the hunter can in an easy way initiate a re-calibration of the system by standing still.

In an embodiment, the method for warning a user sneaking up on a prey will only trigger once per calibration. Thus, if a warning is triggered, the user would have to recalibrate the system again.

In an embodiment, the method for warning a user sneaking up on a prey will have to be reset, if two warnings are given within a period of 5 seconds.

In this way, the user sneaking up on prey will not generate a series of warnings, if the user decides to make noise. A user sneaking up on prey may choose to move through dense bushes or thicket, where it would be very hard otherwise not to trigger the system several times, whereby the warnings would become an unnecessary source of irritation.

In an aspect the method for warning a user sneaking up on a prey may further comprise calibrating acts for an initial calibration, when the user puts on the wearable warning system.

The method may comprise an act of placing one or more acoustic sensors and the alert unit on a user. The wearable warning system will then perform an act of measuring an external sound. The external sound may be the sound of the user walking around or the user clamping hands together or a combination of both. The external sound may be generated by other means.

One or more noise thresholds and/or one or more warning thresholds may be adjusted as a function of the measured external sound at the evaluation unit.

The wearable warning system will then measure a warning generated by the alarm unit and compare the sound level with the warning threshold. If the sound level is above the warning threshold, the sound level is adjusted at the alert unit, and the previous step is repeated. The warning produces some sound, but the warning is only intended for the user of the wearable warning system.

The above mentioned acts will make sure that the acoustic sensors and the alert unit are positioned correctly, and that the sound generated by the warning is below a certain level.

In an aspect of the invention the method for warning a user sneaking up on a prey may further comprise calibrating acts based on user-controlled parameters.

The method may comprise an act of reading one or more user-controlled parameters, e.g. a desired distance to said prey or desired prey.

The noise threshold and said warning threshold of each acoustic sensor may be adjusted based on the one or more parameters at the evaluation unit.

If the user changes the desired distance to said prey by a factor of two, the noise threshold can be 6 dB higher as the prey may be further away.

Other parameters could be but is not limited to the type of prey and the weather conditions.

In a further advantageous embodiment the wearable warning system changes the noise threshold based on the ambient sound. E.g. a sudden wind begins to push the nearby trees, and the leaves start to rustle; this will increase the ambient sound around the user. Thus, the user can make more noise without alerting the prey and therefore the noise threshold is increased.

A computer or handheld smartphone with a processor executing a computer-readable storage or a collection of instructions causes one or more acts previously described to be performed. The computer or handheld smartphone with a processor and storage may further have auxiliaries such as a microphone, a vibrator, a speaker, GPS, a gyroscope and a GUI.

The computer-readable storage or the collection of instructions could be in the form of an app for a smartphone or a similar device. A person skilled in the art of programming would know how to make the app.

A wearable warning system for helping a user to sneak closer to a prey said wearable warning system comprising a processor, computer-read/writeable storage and auxiliaries such as a microphone, a vibrator, a speaker, a gyroscope and/or a Graphical User Interface (GUI) and configured to store instructions and to perform one or more acts previously described.

The stored instructions may be in the form of a computer program, and it may be stored on the storage unit, which is a computer-readable medium.

The storage unit may be a hard disk drive or a solid state disk or a flash memory or an SD card.

The wearable warning system may further comprise a GPS and a computer-writeable storage.

In an aspect of the invention the wearable warning system for helping a user sneak closer to a prey may comprise:
at least one acoustic sensor for measuring at least one sound level,
a storage unit for storing and reading computer instructions and measured sound levels;
an alert unit having means for producing a warning intended to warn the user;
a motion unit for determining when a user is stationary;
an evaluation unit having a user-interface and a processor, said evaluation unit being configured for adjusting one or more noise thresholds of one or more acoustic sensors as a function of the measured sound level at the one or more acoustic sensors and activating the alert unit as a function of one or more noise thresholds.

The wearable warning system may have several acoustic sensors, as they will make it easier to determine how much noise the user is making in different directions. The acoustic sensors may be placed anywhere on the body of the user or attached to the clothes worn by the user.

In an embodiment at least one acoustic sensor is placed at or in shoes worn by the user, thus making it easier to evaluate the noise generated when stepping on e.g. leaves or twigs.

The warning may be an acoustic warning, a vibrational warning, a mechanical warning or a combination.

If the warning is an acoustic warning, the alert unit must be placed near or in or over the ears of the user. The alert unit may be a headphone, an earplug or another acoustic device. The advantage of having an audible warning is that it is possible to give the user more information.

The warning produced by the alert unit may have a sound level above the noise threshold, if and only if the sound generated by the warning is muffled by some shielding means.

E.g. if the warning is a sound generated by a headset, the sound level of the warning may be louder than the noise threshold as the headset can attenuate the warning such that the warning is not audible to anyone but the user, and thus the acoustic sensors will measure a sound level below the warning threshold.

In an embodiment the alert unit may be at one or more vibration units placed at various positions on the user. The vibration unit may be placed in a pocket. The vibrational unit may be attached to a band making it possible to be worn around an arm, a leg or the chest.

In an embodiment the alert unit may be at least one mechanical unit having means to poke the user. The mechanical unit may be attached to a band making it possible to be worn around an arm, a leg or the chest.

In an embodiment the wearable warning system is a smartphone. The advantage of using a smartphone is that it is one single device, which makes it considerably easier to handle.

In another embodiment the wearable warning system is a smartphone in communication with at least one acoustic sensor. Said communication may be wired, wireless or a combination of both. The wireless data communication may be Bluetooth, mobile, Wi-Fi, radio or any other wireless data communication.

In another embodiment the wearable warning system is a smartphone in communication with at least one alarm unit. Said communication may be wired, wireless or a combination of both. The wireless data communication may be Bluetooth, mobile, Wi-Fi, radio or any other wireless data communication.

In another embodiment the wearable warning system is a smartphone in communication with at least one acoustic sensor and at least one alarm unit. Said communication may be wired, wireless or a combination of both. The wireless data communication may be Bluetooth, mobile, Wi-Fi, radio or any other wireless data communication.

In an aspect of the invention the wearable warning system is further configured to link up with other wearable warning systems by communication means, thereby forming a group of warning systems, said wearable warning system may optionally be a master controlling one or more parameters of the wearable warning systems or a slave.

By designating a master it is possible to secure that all the wearable warning systems in the group of warning systems have the same parameters. Thus, any wearable warning system in the group of warning systems will warn the user, when the user makes a noise above the noise threshold.

The communication means between the wearable warning systems may be Bluetooth, mobile, Wi-Fi, radio or any other wireless data communication.

If a warning is communicated to all the wearable warning systems in the group of warning systems, one wearable warning system measures a sound level above the noise threshold, thus limiting the chance of the group making several loud noises in a short amount of time.

In a further advantageous embodiment an audible warning is given to all the wearable warning systems in the group of warning systems, if one wearable warning system measures a sound level above the noise threshold. Said warning may contain information about which wearable warning system that measured the noise. This will further incite the wearers to be as quite as possible, as no one wants to be the one scaring the prey.

The wearable warning system may further comprise a GPS and a computer-writeable storage unit. The advantage of having a GPS and a computer-writeable storage unit is that it is possible to map the route of the user. Furthermore, it is possible to log the place of a warning; this will help the user identify hard to sneak areas, and the user will then know to avoid that area. Another advantage is that the route can be shared with a third party.

The group of warning systems may have at least one GPS and at least one computer-writeable storage unit. The advantage of having a GPS and a computer-writeable storage unit is that it is possible to map the individual route of the users, and afterwards it would be possible to rank the users based on the number of warnings generated by the individual user.

The wearable warning system may be used by a hunter for hunting game.

The wearable warning system may be used by a group of hunters for hunting game.

The wearable warning system may be used by a user sneaking up on a human being.

The wearable warning system may be used by a user for staying quiet.

In an embodiment, the user may be a pupil in a school having difficulties with staying quiet during class. The wearable warning system will warn the pupil, when he/she makes too much noise.

In an embodiment the user may be a person at a social gathering having difficulties staying quiet.

In an embodiment the user may be a person wishing to stay quieter than the person's surroundings. The above mentioned positive effects of a user sneaking up on a prey would also be present for a person/user wishing to stay quiet.

The person may be an ornithologist watching birds.

Item List

| Item | No |
|---|---|
| Wearable warning system | 10 |
| User | 20 |
| Human | 21 |
| Prey | 22 |
| Hunter | 24 |
| Game | 26 |
| Group of users | 28 |
| Group of hunters | 29 |
| Acoustic sensor | 30 |
| Sound level | 32 |
| Evaluation unit | 40 |
| User-interface | 42 |
| Parameter | 44 |
| Noise threshold | 46 |
| Warning threshold | 48 |
| Alert unit | 50 |
| Warning | 52 |
| Acoustic warning | 54 |
| Vibrational warning | 56 |
| Mechanical warning | 58 |
| Storage unit | 60 |
| External sound | 62 |
| Motion unit | 65 |
| Predetermined time duration | 67 |
| Group of warning systems | 70 |
| Communication means | 72 |
| Master | 74 |
| Slave | 76 |
| Desired distance | 80 |
| Map | 90 |
| Route | 92 |
| Method for warning | 100 |
| Providing | 110 |
| Linking | 120 |
| Measuring | 130, 220 |
| Comparing | 140 |
| Activating | 150 |
| Generating | 160 |
| Placing | 210 |
| Adjusting | 230 |
| Reading | 240 |
| Determining | 250 |
| Storing | 260 |

### BRIEF DESCRIPTION OF DRAWINGS

Embodiments of the invention will be described in the figures, wherein:

FIG. 1 illustrates a user wearing the wearable warning system;

FIG. 2 illustrates a method for warning a user sneaking up on prey;

FIG. 3 illustrates a user wearing the wearable warning system further comprising a motion unit; and

FIG. 4 illustrates a method for warning a user sneaking up on prey, the method further utilising the motion unit.

FIG. 5 illustrates a method for warning a user sneaking up on prey, the method further comprising calibrating acts;

FIG. 6 illustrates another method for warning a user sneaking up on prey, the method further comprising calibrating acts;

FIG. 7 illustrates the user-interface of the evaluation unit;

FIG. 8 illustrates a group of warning systems;

FIG. 9 illustrates a group of warning systems sneaking up on a prey;

FIG. 10 illustrates a route on a map;

FIG. 11 illustrates a method for warning a group of users sneaking up on prey;

### DETAILED DESCRIPTION OF DRAWINGS

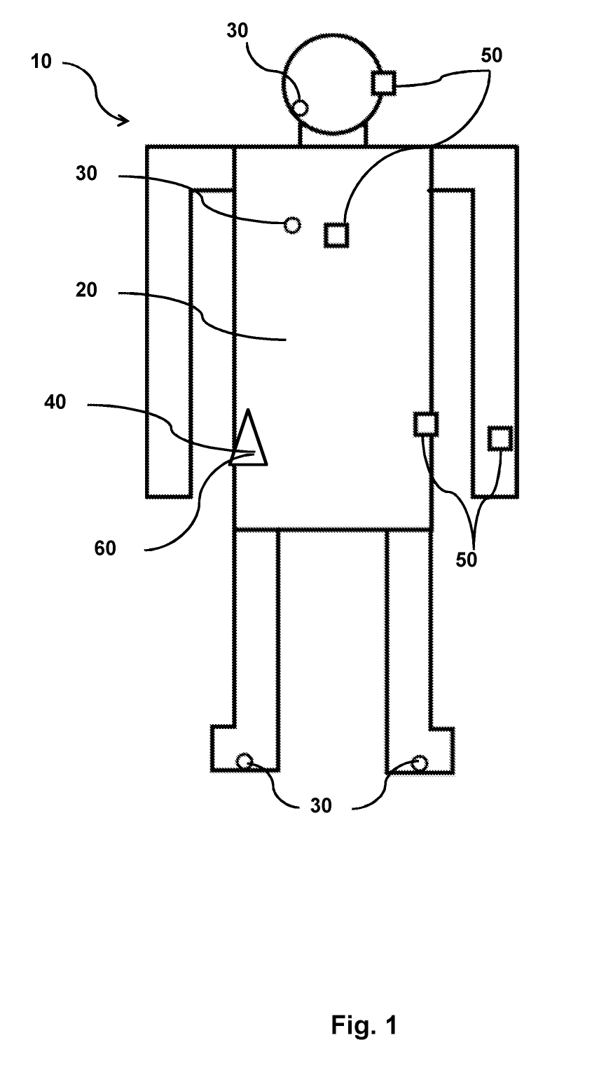

FIG. 1 discloses a user 20 wearing the wearable warning system 10. This wearable warning system 10 comprises one or more acoustic sensors 30, an evaluation unit 40, a storage unit 60 and one or more alert units 50. In the figure acoustic sensors 30 are represented by a small circle, the evaluation unit 40 is represented by a triangle, the storage unit 60 is in this embodiment part of the evaluation unit and the alert units 50 are represented by a small square. The invention is not thought to be limited to the positions shown or the number of components. Typically the wearable warning system 10 will only have a single alert unit 50.

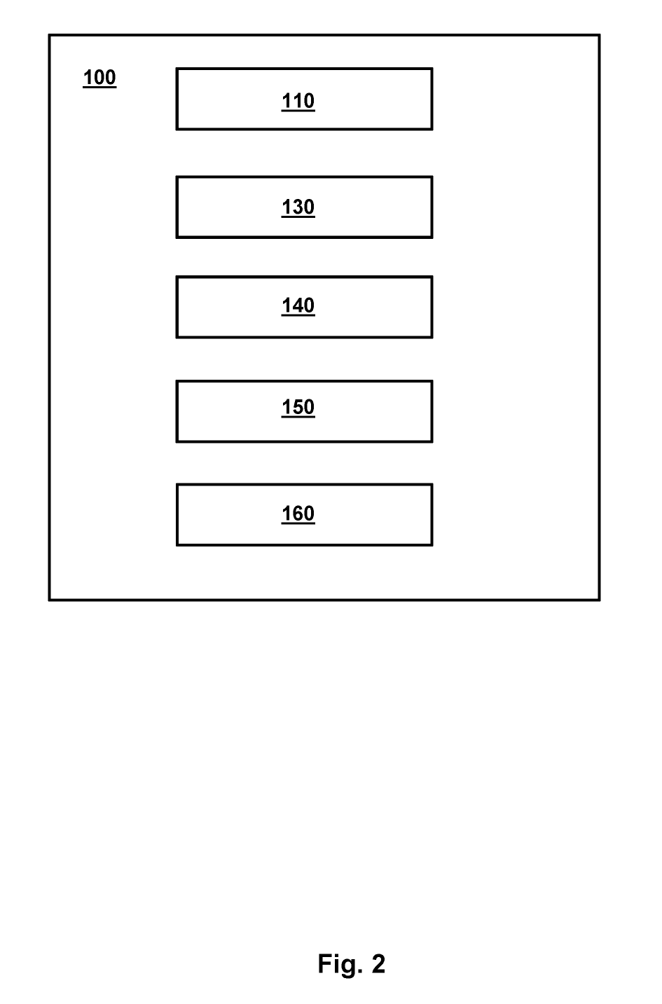

FIG. 2 discloses a method 100 for warning a user 10 sneaking up on prey 22. Said method 100 for warning comprises an act of providing 110 the user 20 with a wearable warning system 10 comprising at least one acoustic sensor 30, an evaluation unit 40 having a processor, an alert unit 50 and a storage unit 60. An act of measuring 130 a sound level 32 at one or more acoustic sensors 32 is performed. The evaluation unit 40 performs an act of comparing 140 one or more of the measured sound levels 32 with at least one noise threshold 46, and if one of the sound levels is 32 above a noise threshold 46, the evaluation unit 40 performs an act of activating 150 the alert unit 50. The alert unit 50 will upon activation perform an act of generating 160 a warning 52.

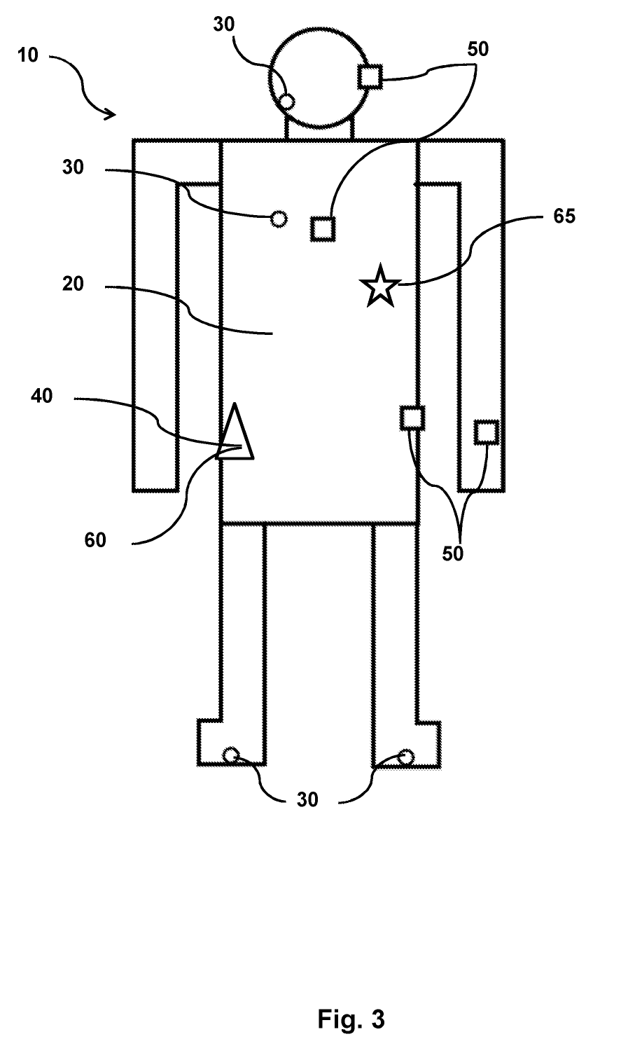

FIG. 3 discloses a user 20 wearing the wearable warning system 10. This wearable warning system 10 comprises one or more acoustic sensors 30, an evaluation unit 40, storage unit 60, a motion unit and one or more alert units 50. In the figure acoustic sensors 30 are represented by a small circle, the evaluation unit 40 is represented by a triangle, the storage unit 60 is in this embodiment part of the evaluation unit, the motion unit 65 is represented by the star, and the alert units 50 are represented by a small square. The invention is not thought to be limited to the positions shown or the number of components. Typically, the wearable warning system 10 will only have a single alert unit 50.

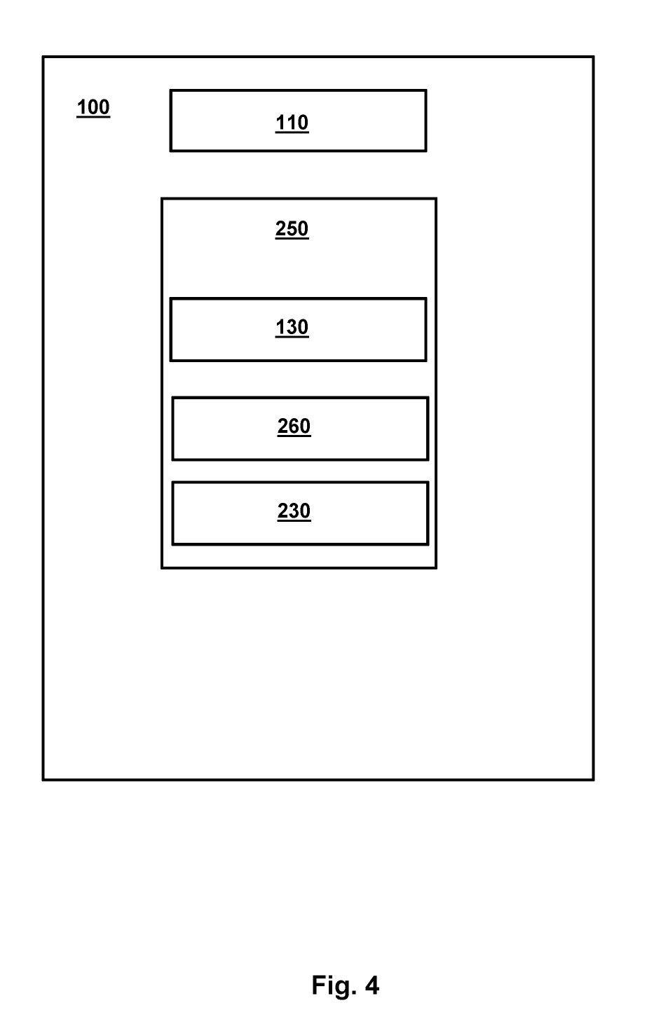

FIG. 4 discloses a method 100 for warning a user 20 sneaking up on a prey 22 comprising calibrating acts of:
providing 110 a wearable warning system 10 comprising at least one acoustic sensor 30, an evaluation unit 40 having a processor, an alert unit 50, a motion unit 65 and a storage unit 60.
determining 250 when the user 20 is stationary, and while the user 20 is stationary;
   measuring 130 the sound 32 at the one or more acoustic sensors 30;
   storing 260 the measured sound level 32 at the one or more acoustic sensors 30 on the storage unit 60; and if the user 20 is stationary in a predetermined time duration 67;
   the evaluation unit 40 performs an act of adjusting 230 the one or more noise thresholds 46 of one or more acoustic sensors 30 as a function of the measured sound level 32 at the one or more acoustic sensors 30.

The method 100 enables the user to control the wearable warning system 10 without using hands.

If the user is a hunter hunting game, the above mentioned calibrating acts enables the wearable warning system to utilise the hunter's expert knowledge.

The method disclosed in FIG. 2 will continuously run in the background will the above mentioned acts are performed. Thus, if a sound level 32 is measured above the noise threshold 46, a warning 52 is generated by the alert unit 50.

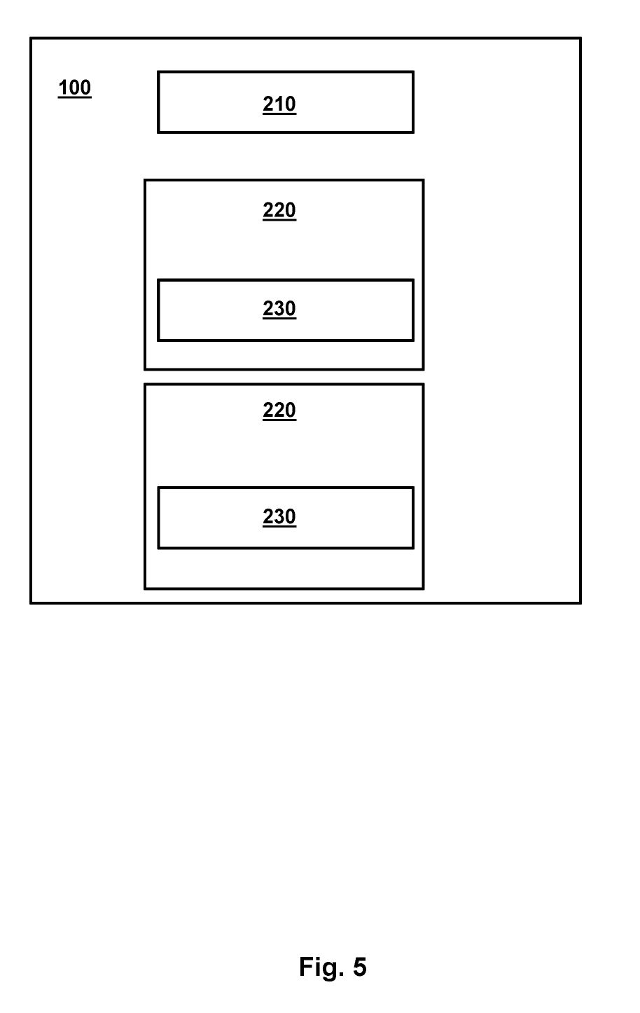

FIG. 5 discloses a method 100 for warning a user 20 sneaking up on a prey 22. The method 100 comprises an act of placing 210 one or more acoustic sensors 30 and the warning alert 50 on a user 20. The wearable warning system 10 will then perform an act of measuring 220 to an external sound 62.

The external sound 62 may be the sound of the user 20 walking around or the user 20 clamping hands together or a combination of both. The external sound 62 may be generated by other means.

The method 100 further comprises the act of adjusting 230 one or more noise thresholds 46 and/or one or more warning thresholds 48 of one or more acoustic sensors 30 as a function of the measured external sound 62 at the evaluation unit 40.

The wearable warning system 10 will then perform an act of measuring 220 to a warning 52 generated by the alarm unit 50 and compare the sound level 32 with the warning threshold 48. If the sound level is above the warning threshold 48, the sound level 32 is adjusted at the alert unit, and the previous step is repeated.

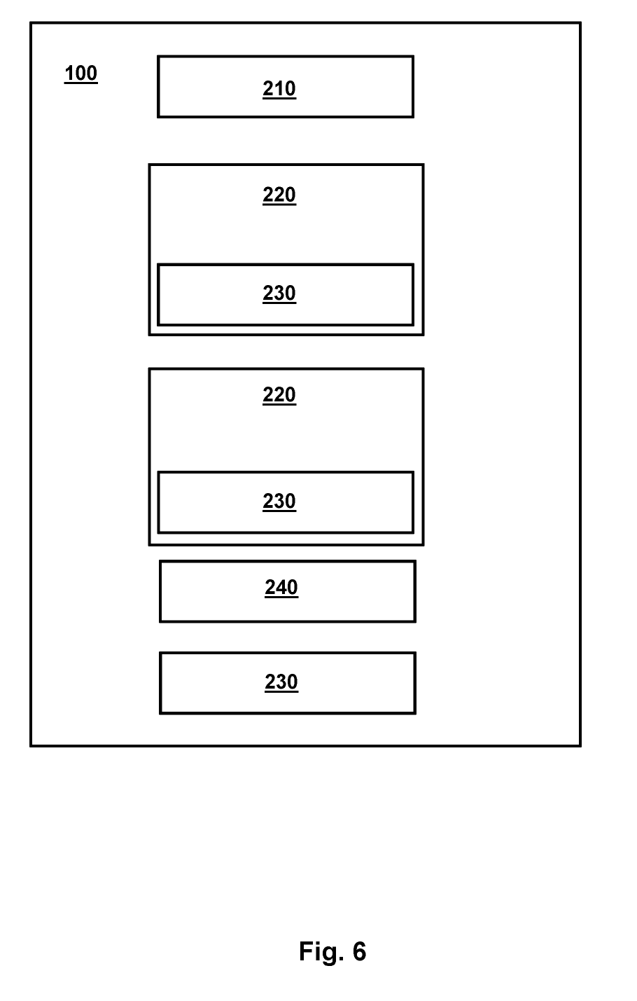

FIG. 6 illustrates a second method 100 for warning a user 20 sneaking up on a prey 22. The method 100 comprises an act of placing 210 the one or more acoustic sensors 30 and the alert unit 50 on a user 20. The wearable warning system 10 will then perform an act of measuring 220 to an external sound 62.

The external sound 62 may be the sound of the user 20 walking around or the user 20 clamping hands together or a combination of both. The external sound 62 may be generated by other means.

The method 100 further comprises the act of adjusting 230 one or more noise thresholds 46 and/or one or more warning thresholds 48 of one or more acoustic sensors 30 as a function of the measured external sound 62 at the evaluation unit 40.

The method 100 will then perform an act of measuring 220 a warning 52 generated by the alarm unit 50 and compare the sound level 32 with the warning threshold 48. If the sound level is above the warning threshold 48, the sound level 32 of the warning 52 is adjusted at the alert units, and the previous step is repeated.

The method 100 will then perform an act of reading 240 one or more user-controlled parameters 44, e.g. a desired distance 80 to said prey 22.

The method 100 will then perform an act of adjusting 230 said noise threshold of each acoustic sensor 30 and/or said warning threshold 48 based on one or more parameters 44 at the evaluation unit 40.

If the user 20 increases the desired distance 80 to said prey 22 by a factor of two, the noise threshold 46 can be 6 dB higher as the prey 22 is further away.

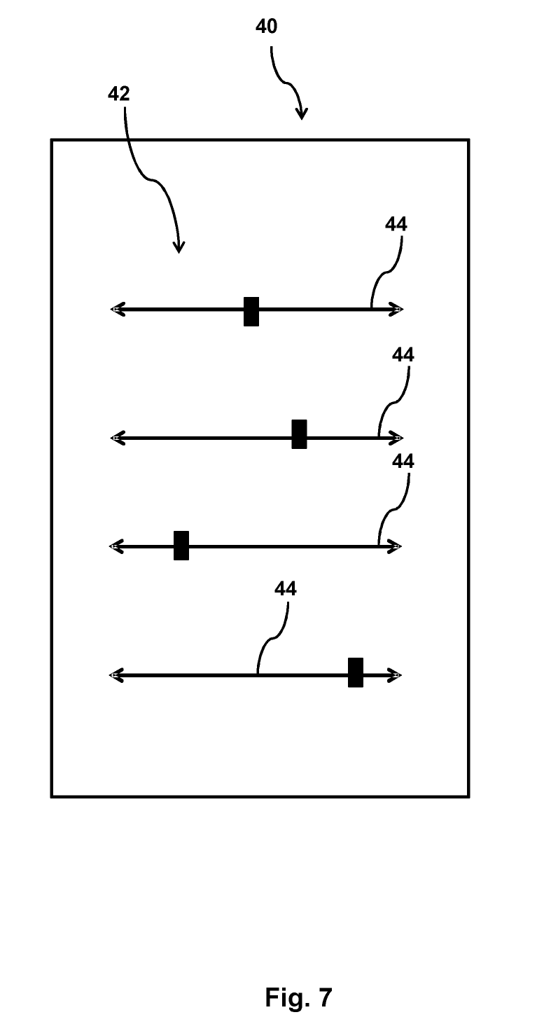

FIG. 7 discloses the user-interface 42 of the evaluation unit 40. In this figure, four different parameters 44 can be changed by sliding the bars back and forth.

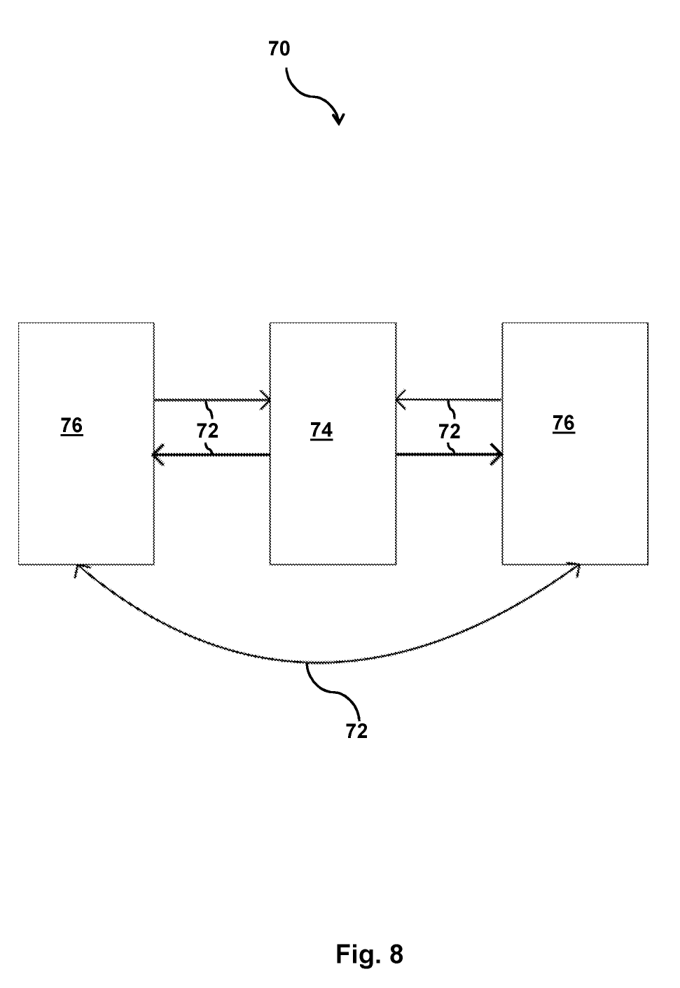

FIG. 8 discloses three wearable warning systems 10 communicating by communication means 72 thereby forming a group of warning systems 70. The wearable warning system 10 in the middle is designated to be the master 74, and the two wearable warning systems 10 are both slaves 76.

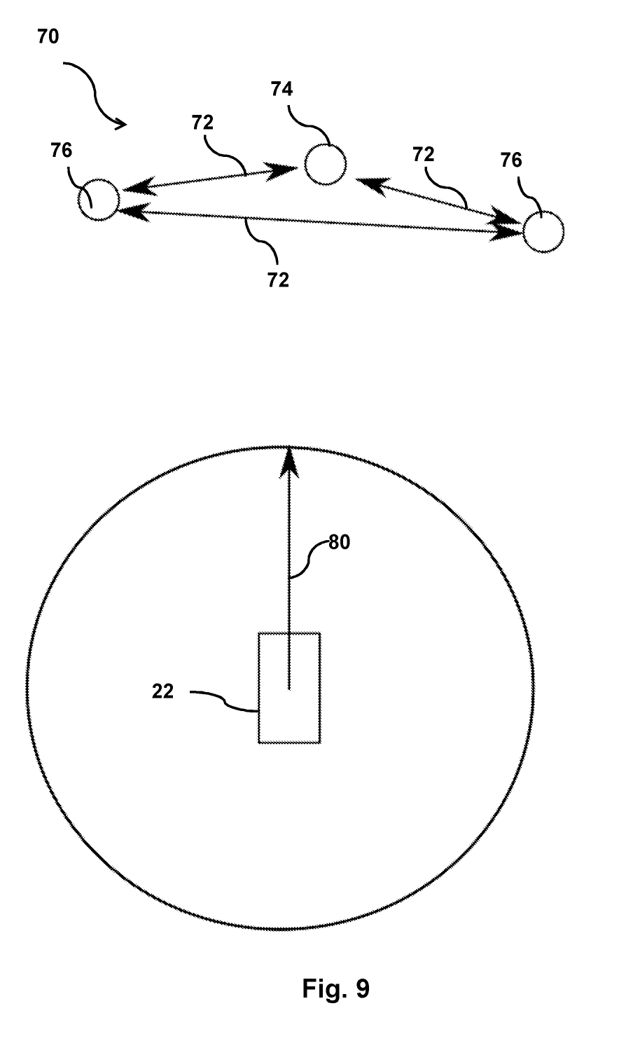

FIG. 9 discloses three wearable warning systems 10 communicating by communication means 72 thereby forming a group of warning systems 70. The wearable warning system 10 in the middle is designated to be the master 74, and the two wearable warning systems 10 are both slaves 76. The group of warning systems 70 are sneaking up on a prey 22. The figure further discloses a desired distance 80, which could be the desired shooting distance.

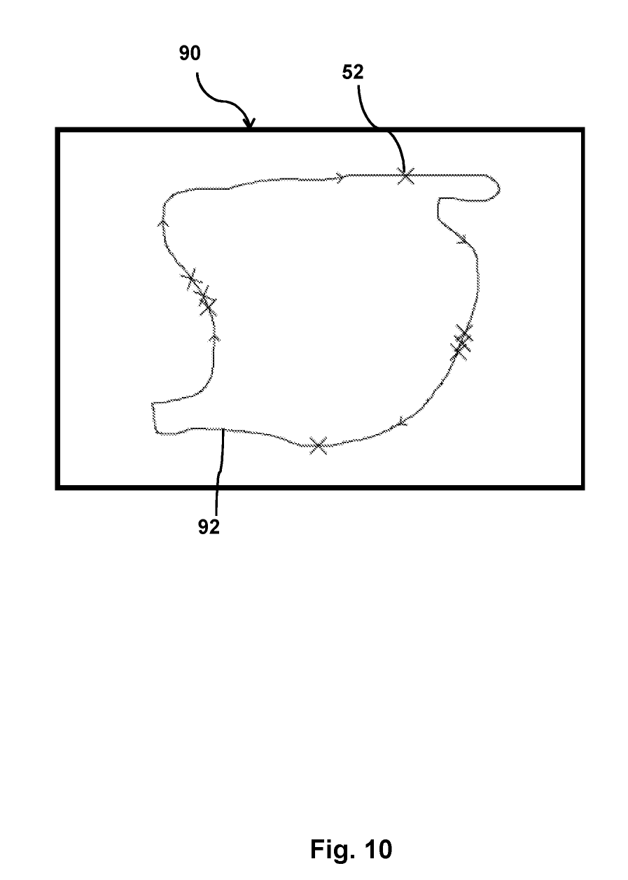

FIG. 10 discloses a map 90 drawn with the route 92 taken by a user 20 of the wearable warning system 10. The warning 52 is represented on the map 90 by a cross. The map 90 shows where it is hard to sneak, so that the user 20 at another time may choose a different route 92.

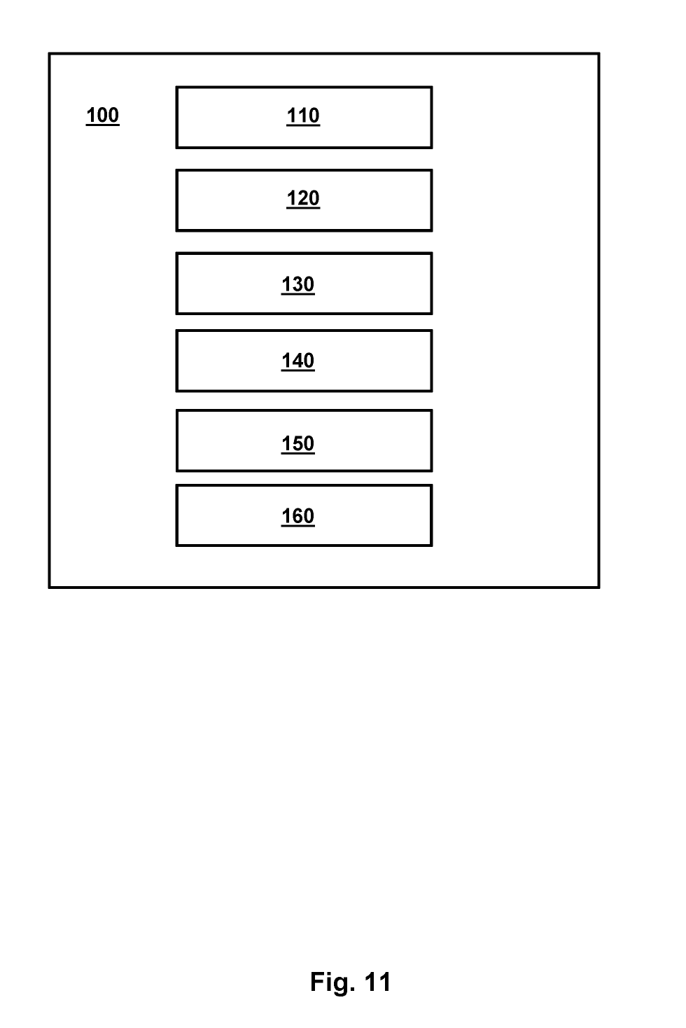

FIG. 11 discloses a method 100 for warning a group of users 28 sneaking up on prey 22. Said method 100 for warning comprises an act of providing 110 each user 20 with a wearable warning system 10 comprising of at least one acoustic sensor 30, an evaluation unit 40 and an alert unit 50. An act of linking 120 together the wearable warning systems 10 will be performed by communication means 72. The wearable warning systems 10 will each perform one or more acts of measuring 130 a sound level 32 at one or more acoustic sensors 30.

Each evaluation unit 40 performs one or more acts of comparing 140 one or more of the measured sound levels 32 with at least one noise threshold 46, and if one of the sound levels 32 is above a noise threshold 46, said evaluation unit 40 will perform an act of activating 150 one or more alert units 50 in the group of warning systems 70. Each alert unit 50 will upon activation perform an act of generating 160 a warning 52.

1. A method for warning a user sneaking up on a prey, which method comprises acts of:
providing a wearable warning system comprising at least one acoustic sensor, an evaluation unit having a processor, an alert unit and a storage unit;
measuring a sound level at one or more acoustic sensors;
comparing one or more sound levels at one or more acoustic sensors with at least one noise threshold at the evaluation unit, and when a sound level at one acoustic sensor is above a noise threshold;
activating said alert unit; and
generating a warning.

2. A method for warning a user sneaking up on a prey according to claim 1, which method comprises calibrating acts of:
providing the wearable warning system further comprising a motion unit for determining when the user is stationary;
determining when the user is stationary, and while the user is stationary;
measuring the sound at the one or more acoustic sensors;
storing the measured sound level at the one or more acoustic sensors on the storage unit;
and if the user is stationary in a predetermined time duration;
the evaluation unit performs an act of adjusting the one or more noise thresholds of one or more acoustic sensors as a function of the measured sound level at the one or more acoustic sensors.

3. A method for warning a user sneaking up on a prey according to claim 1, which method further comprises calibrating acts of:
placing the one or more acoustic sensors and the alert unit on a user;
measuring an external sound at one or more acoustic sensors;
adjusting one or more noise thresholds and one or more warning thresholds of one or more acoustic sensors as a function of the measured external sound at the evaluation unit;
generating a warning;
measuring the warning at one or more acoustic sensors; and
adjusting the sound level of the warning as a function of the measured warning at the alert unit.

4. A method for warning a user sneaking up on a prey according to claim 1, which method further comprises calibrating acts of:
reading one or more user-controlled parameters a desired distance to said prey;
adjusting said noise threshold of each acoustic sensor and/or said warning threshold based on the one or more parameters at the evaluation unit.

5. A method for warning a group of users sneaking up on a prey according to claim 1, which method comprises acts of:
providing each user with a wearable warning system comprising of at least one acoustic sensor, an evaluation unit and an alert unit;
linking each wearable warning system in a group of warning systems;
measuring a sound level at one or more acoustic sensors;
comparing one or more sound levels at one or more acoustic sensors with at least one noise threshold at each evaluation unit, and when a sound level at one acoustic sensor is above a noise threshold;
activating one or more alert units in the group of warning systems; and
generating a warning.

6. A computer-readable storage or a collection of instructions when executed by a computer or handheld smartphone with a processor causes to perform acts according to claim 1.

7. A wearable warning system for helping a user to sneak closer to a prey, said wearable warning system comprising a processor, a computer-read/writeable storage and auxiliaries such as a microphone, a vibrator, a speaker, a gyroscope and/or a Graphical User Interface (GUI) and configured to store instructions and perform actions according to claim 1.

8. A wearable warning system for helping a user sneak closer to a prey, said wearable warning system comprising:
at least one acoustic sensor for measuring at least one sound level,
a storage unit for storing and reading computer instructions and measured sound levels;
an alert unit having means for producing a warning intended to warn the user;
a motion unit for determining when a user stationary;
an evaluation unit having a user-interface and a processor, said evaluation unit being configured for adjusting one or more noise thresholds of one or more acoustic sensors as a function of the measured sound level at the one or more acoustic sensors and activating the alert unit as a function of one or more noise thresholds.

9. A wearable warning system (10) according to claim 7 characterised in that the wearable warning system is further configured to link up with other wearable warning systems by communication means, thereby forming a group of warning systems, said wearable warning system may optionally be a master controlling the one or more parameters of the wearable warning systems or a slave.

10. A group of warning systems comprising multiple wearable warning systems according to claim 9.

11. A method of using the wearable warning system by a hunter according to claim 1 for hunting game.

12. A method of using a group of warning systems by a group of hunters according to claim 1 for hunting game.

13. A method of using the wearable warning system by a user according to claim for sneaking up on a human.

14. A method of using the wearable warning system by a user according to claim 1 for staying quiet.
